(19) United States
(12) Patent Application Publication
(10) Pub. No.: US 2017/0129093 A1
(43) Pub. Date: May 11, 2017

(54) Grip Strap Providing Anti-shock and Ventilating

(71) Applicant: Leo Jaw, Taichung City (TW)

(72) Inventor: Leo Jaw, Taichung City (TW)

(21) Appl. No.: 15/413,471

(22) Filed: Jan. 24, 2017

Related U.S. Application Data
(63) Continuation-in-part of application No. 14/461,461, filed on Aug. 18, 2014.

(51) Int. Cl. B25G 1/01; B32B 27/40; A63B 60/54; A63B 60/14; A63B 60/18; B32B 3/08; B32B 27/30

(52) U.S. Cl. CPC B25G 1/01; B32B 3/085; B32B 27/40; B32B 27/306; A63B 60/14; A63B 60/18; A63B 60/54; B32B 2307/51; B32B 2307/56; B32B 2307/744; A63B 2209/00

(57) ABSTRACT

A grip strap providing anti-shock and ventilating effects includes a strap body including a front side and a back side opposing the front side. A cushion layer including a first side attached to the back side of the strap body and a second side opposing the first side. The cushion layer forms a plurality protruded elastic members disposed on the second side and arranged separately from one another. Each of the plurality of elastic members protrudes from the second side of the strap body in a direction away from the front side of the strap body. Each of the plurality of elastic members includes an adhesive layer disposed thereon, which has two opposite attaching sides and includes one of the two attaching sides attaching to a top edge of the corresponding elastic member.

### CROSS REFERENCE TO RELATED APPLICATION

The present application is a continuation-in-part application of U.S. patent application Ser. No. 14/461,461 filed on Aug. 18, 2014.

### BACKGROUND OF THE INVENTION

1. Field of the Invention

The present invention relates to a grip strap and, particularly, to a grip strap providing anti-shock and ventilating effects.

2. Description of the Related Art

TW Pat. No. M368467 shows a grip strap. The grip strap is elongated. The grip strap includes a fabric layer and an elastic layer. The fabric layer has a plurality of orifices. The elastic layer is made of a form, e.g., LATEX or natural rubber (NR). The elastic layer is adhered to a side of the fabric layer. The side of the fabric layer is in a surface contact with a first attach side of the elastic layer. The elastic layer has a sheet and a plurality of permeable sections. When the grip strap is wrapped around a handle, it includes a second attach side of the elastic layer facing and abutting against the outer periphery of the handle. The first and second attach sides of the elastic layer are opposite from each other. Therefore, the second side of the elastic layer is in frictional contact with the handle. Additionally, the second side of the elastic layer contacts with the outer periphery of the handle without any gaps. The grip strap does not allow a user, when gripping the handle, to experience effectual anti-shock and ventilating effects.

The present invention is, therefore, intended to obviate or at least alleviate the problems encountered in the prior art.

### SUMMARY OF THE INVENTION

According to the present invention, a grip strap providing anti-shock and ventilating effects includes a strap body including a front side and a back side opposing the front side. A cushion layer includes a first side attached to the back side of the strap body and a second side opposing the first side. The cushion layer forms a plurality protruded elastic members disposed on the second side and arranged separately from one another. Each of the plurality of elastic members protrudes from the second side of the strap body in a direction away from the front side of the strap body. Each of the plurality of elastic members includes an adhesive layer disposed thereon, which has two opposite attaching sides and includes one of the two attaching sides attaching to a top edge of the corresponding elastic member.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an object of the present invention to provide a grip strap providing anti-shock and ventilating effects.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a grip strap providing anti-shock and ventilating effects in accordance with the present invention.

FIG. 2 is a cross-sectional view taken along line 2-2 of FIG. 1.

FIG. 3 shows the grip strap of the present invention in use with a handle, with the grip strap wrapping around a handle.

FIG. 4 shows a user gripping the grip strap and the handle shown in FIG. 3.

FIG. 5 shows air flowing between the grip strap and the handle after the user pressing the grip strap.

FIG. 6 is a cross-sectional view showing air ventilating in the grip strap.

### DETAILED DESCRIPTION OF THE INVENTION

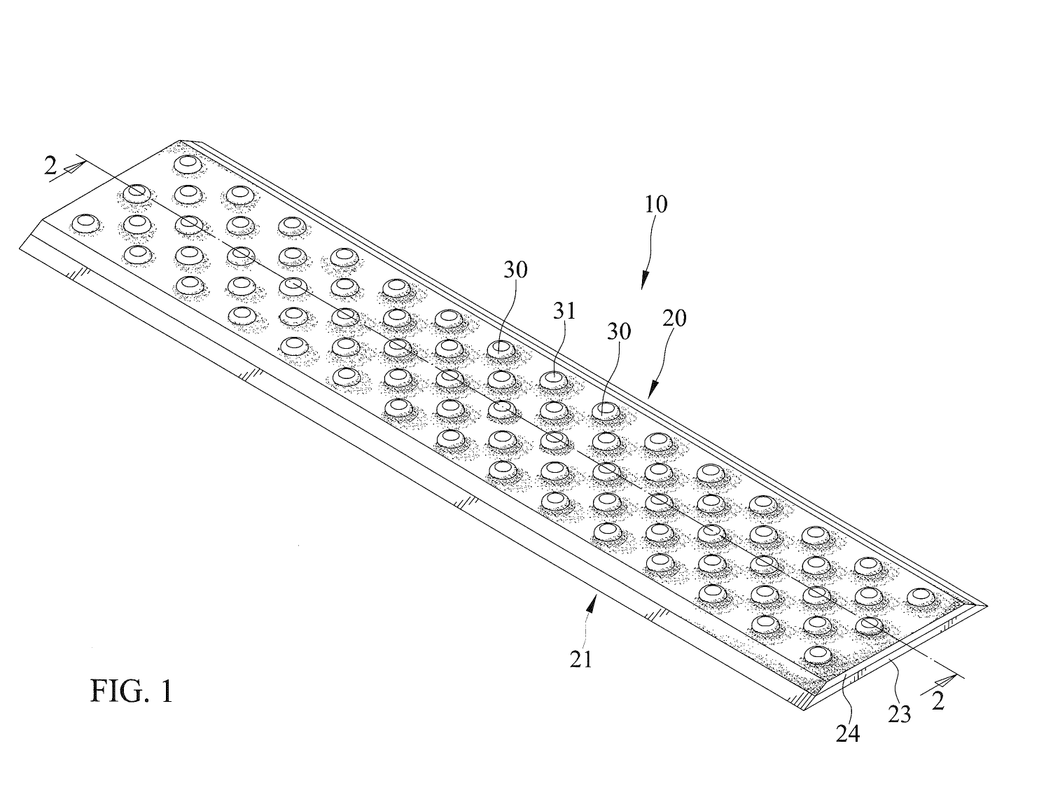

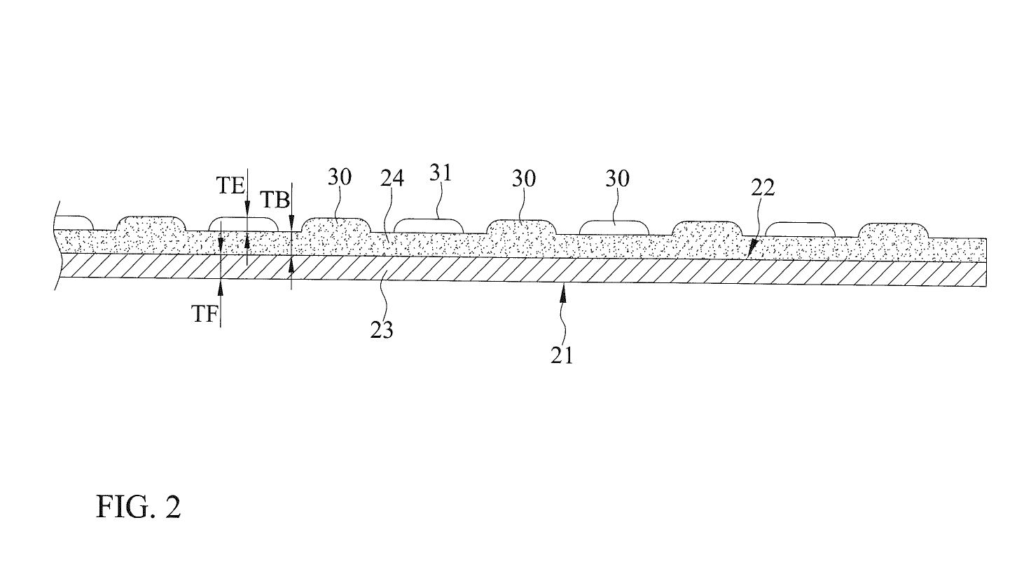

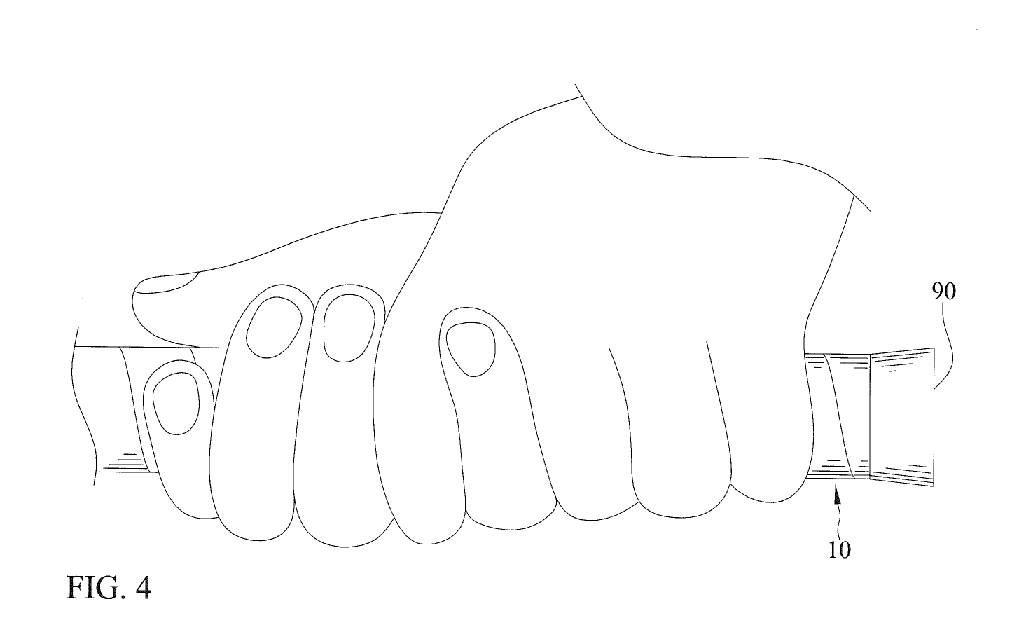

FIGS. 1 through 6 show a grip strap 10 providing anti-shock and ventilating effects in accordance with the present invention. The grip strap 10 includes a strap body 20 with a front side 21 and a back side 22 opposing the front side 21. The front side 21 of the strap body 20 is a flat smooth edge without any cavities. The strap body 20 is elongated. The strap body 20 defines a substrate 23.

A cushion layer 24 includes a first side attached to the back side of the strap body and a second side opposing the first side. The cushion layer 24 overlaps the substrate 23. The substrate 23 and the cushion layer 24 are arranged in the thickness direction of the strap body 20. The cushion layer 24 has an original thickness defining a first thickness TB in a thickness direction of the strap body 20. The cushion layer 24 is made of an elastomer material. The cushion layer 24 is made of Ethylene Vinyl Acetate (EVA) or Thermoplastic Polyurethane (TPU).

The cushion layer 24 forms a plurality protruded elastic members 30 disposed on the second side and arranged separately from one another. Each of the plurality of elastic members 30 protrudes from the back side of the strap body 20 in a direction away from the front side of the strap body 20. The plurality of elastic members 30 does not contact with one another, and a space is formed between two adjacent elastic members 30. Each of the plurality of elastic members 30 has a top edge, and the top edges are at the same height. The plurality of elastic members 30 is disposed along the longitudinal length direction of strap body 20. The thickness direction of the strap body 20 is perpendicular to a longitudinal length direction of the strap body 20. Each of the plurality of elastic member 30 has an original thickness defining a second thickness TE in the thickness direction of the strap body 20. The second thickness TE is not less than half of the first thickness TB. The second thickness TE is not greater than the first thickness TB. Each of the plurality of the elastic members 30 has a circular circumferential shape, but not limited thereto. The substrate 23 has an original thickness defining a third thickness TF in the thickness direction of the strap body 20. The first thickness TB is between 0.8 and 1.2 times of the third thickness TF. The first thickness TB equals to the third thickness TF.

Each of the plurality of elastic members 30 includes an adhesive layer 31 disposed thereon, which has two opposite attaching sides and includes one of the two attaching sides attaching to the top edge of the corresponding elastic member 30.

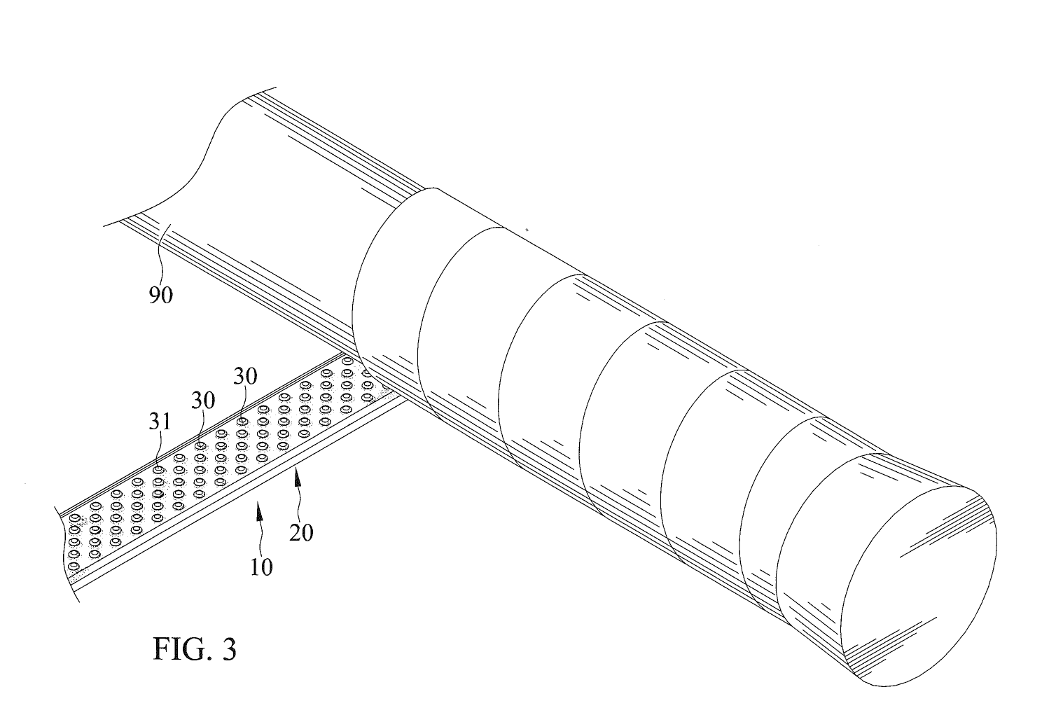

As shown in FIG. 3, the grip strap 10 is wrapped and attached spirally around the handle 90. The plurality of elastic members 30 includes the corresponding adhesive layer 31 abutting against the handle 90. The plurality of the elastic members 30 is disposed between the strap body 20 and the handle 90. A user grips on the front side 21 of the strap body 20 when gripping the grip strap 10 and the handle 90. Each of the plurality of elastic members 30 includes another attaching side attached to and in frictional contact with the outer periphery of the handle 90, and the grip strap 10 is prevented from slipping relative to the handle 90 inadvertently. Further, since the front side 21 of the strap body 20 is smooth and flat, the user can comfortably grip on the front side 21 of the strap body 20.

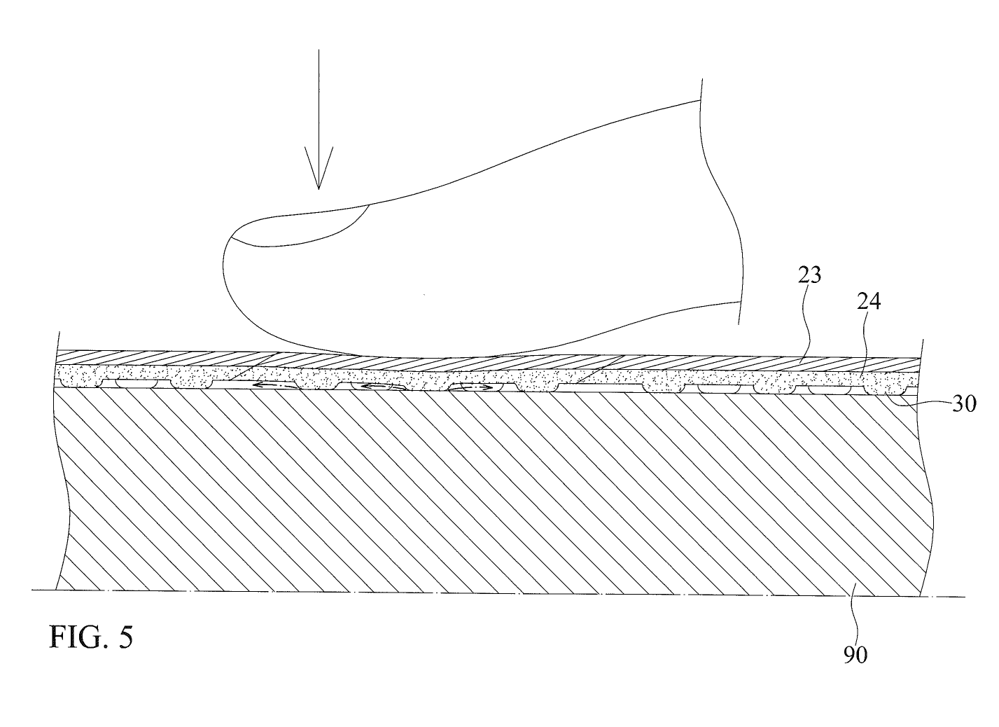

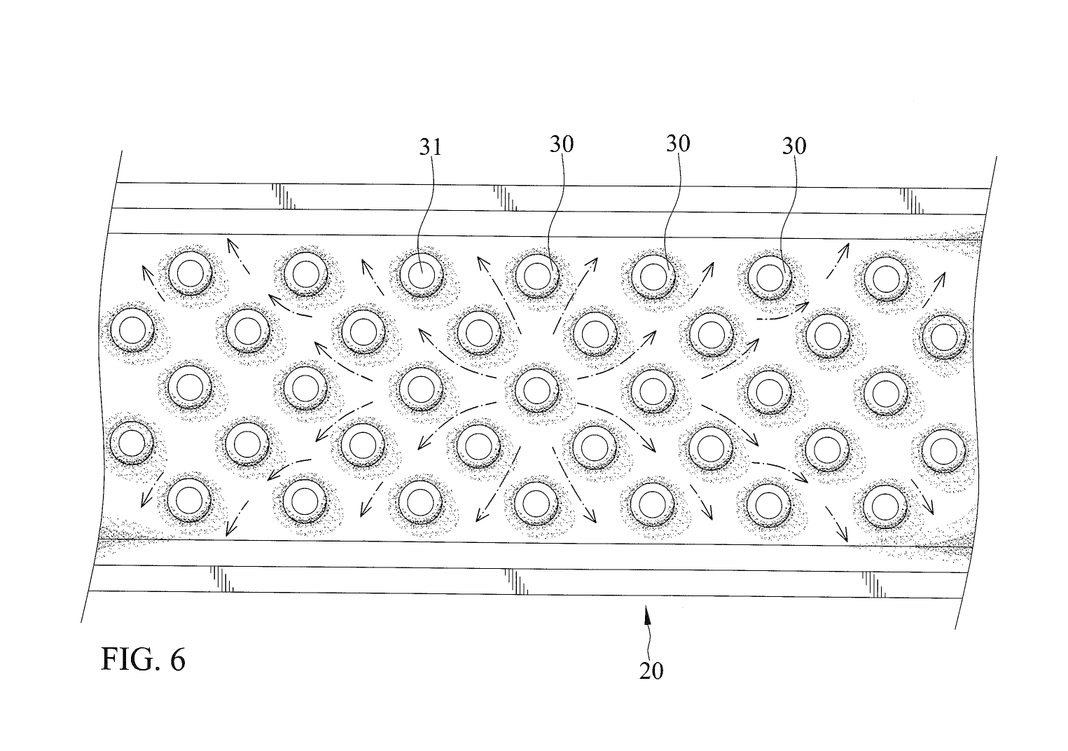

As shown in FIGS. 5 and 6, the space between two adjacent elastic members 30 defines an air channel, and the air channel is disposed between the second side of the cushion layer 24 and the outer periphery of the handle 90.

In view of the forgoing, the cushion layer 24 and the elastic members 30 respectively provides an anti-shock effect, and the plurality of air channels can not only absorbs impact but also provides a ventilating effect.

The foregoing is merely illustrative of the principles of this invention and various modifications can be made by those skilled in the art without departing from the scope and spirit of the invention.

What is claimed is:

1. A grip strap providing anti-shock and ventilating effects comprising:
a strap body including a front side and a back side opposing the front side; and
A cushion layer including a first side attached to the back side of the strap body and a second side opposing the first side and forming a plurality protruded elastic members disposed on the second side and arranged separately from one another, with each of the plurality of elastic members protruding from the back side of the strap body in a direction away from the front side of the strap body, and wherein each of the plurality of elastic members includes an adhesive layer disposed thereon, which has two opposite attaching sides and includes one of the two attaching sides attaching the corresponding elastic member.

2. The grip strap as claimed in claim 1, wherein the strap body defines a substrate and a cushion layer overlapping the substrate, with the substrate and the cushion layer arranged in a thickness direction of the strap body, and wherein the substrate is adjacent to the front side of the strap body and the cushion layer is adjacent to the back side of the strap body, respectively.

3. The grip strap as claimed in claim 2, wherein the cushion layer has an original thickness defining a first thickness in the thickness direction of the strap body, wherein each of the plurality of elastic member has an original thickness defining a second thickness in the thickness direction of the strap body, and wherein the second thickness is not less than half of the first thickness.

4. The grip strap as claimed in claim 3, wherein the second thickness is not greater than the first thickness.

5. The grip strap as claimed in claim 3, wherein the substrate has an original thickness defining a third thickness in the thickness direction of the strap body, and wherein the first thickness is between 0.8 and 1.2 times of the third thickness.

6. The grip strap as claimed in claim 5, wherein the first thickness equals to the third thickness.

7. The grip strap as claimed in claim 2, wherein the cushion layer is made of an elastomer material.

8. The grip strap as claimed in claim 7, wherein the cushion layer (24) is made of Ethylene Vinyl Acetate.

9. The grip strap as claimed in claim 7, wherein the cushion layer (24) is made of Thermoplastic Polyurethane.

10. The grip strap as claimed in claim 1, wherein the plurality of elastic members and the cushion layer are connected together by an integral forming method.

11. The grip strap as claimed in claim 1, wherein the top edges of the plurality of elastic members are at the same height.

12. The grip strap as claimed in claim 1, wherein the plurality of elastic members is disposed along the longitudinal length direction of strap body.

13. The grip strap as claimed in claim 1, wherein the front side of the strap body is a flat smooth edge without any cavities.

14. The grip strap as claimed in claim 1, wherein a space is formed between two adjacent elastic members and defines an air channel.

15. The grip strap as claimed in claim 1, wherein another attaching side of the adhesive layer on one of the plurality of elastic members is attached to a handle, wherein the air channel between two adjacent elastic members is disposed between the second side of the strap body and the handle.
